(19) United States
(12) Patent Application Publication
(10) Pub. No.: US 2023/0088679 A1
(43) Pub. Date: Mar. 23, 2023

(54) DEVICE AND METHOD FOR DETECTING MICROBEND IN OPTICAL FIBER

(71) Applicant: NIPPON TELEGRAPH AND TELEPHONE CORPORATION, Tokyo (JP)

(72) Inventors: Kazutaka NOTO, Musashino-shi, Tokyo (JP); Nazuki HONDA, Musashino-shi, Tokyo (JP); Hiroyuki OSHIDA, Musashino-shi, Tokyo (JP)

(73) Assignee: NIPPON TELEGRAPH AND TELEPHONE CORPORATION, Tokyo (JP)

(21) Appl. No.: 17/798,535

(22) PCT Filed: Feb. 13, 2020
(86) PCT No.: PCT/JP2020/005594

§ 371 Date: Aug. 9, 2022

(51) Int. Cl. G01D 5/353; G01L 1/24; G01K 11/322; G01H 9/00

(52) U.S. Cl. CPC G01D 5/35364; G01L 1/242; G01K 11/322; G01H 9/004

(57) ABSTRACT

An object of the present disclosure is to detect a microbend in an optical fiber before the light-receiving intensity of a transmission device decreases. The present disclosure relates to a device configured to measure guided acoustic wave Brillouin scattering in a measurement target optical fiber, and detect a microbend in the measurement target optical fiber based on a characteristic around a peak of the guided acoustic wave Brillouin scattering.

### TECHNICAL FIELD

The present invention relates to maintenance and operation of an optical fiber.

### BACKGROUND ART

If water permeates the covering of an optical fiber, a microbend may occur. An increase in microbend loss that is caused particularly by immersion gradually varies and thus is essential for maintenance of an optical fiber. As a method for detecting a loss caused by a microbend, there is a method for measuring a transmission loss using an OTDR (Optical Time Domain Reflectometer), or a method for measuring an optical loss using an optical power meter.

### CITATION LIST

### Patent Literature

[PTL 1] Japanese Patent Application Publication 2015-206594

### Non Patent Literature

[NPL 1] Hirofumi Amano, “All about access networks”, p. 52, The Telecommunications Association, Jul. 1, 2017
[NPL 2] Hiroshi Takahashi et al. “The branch optical fiber loss measurement technique allowing End-to-End measurement of an optical access line”, NTT Technical Review, December, 2017, pp 58-62.

### SUMMARY OF THE INVENTION

### Technical Problem

However, in the detection using a loss, the measurement is only possible after the light-receiving intensity of a transmission device is reduced. Accordingly, there may be cases where services are affected.

Therefore, an object of the present disclosure is to detect a microbend in an optical fiber before the light-receiving intensity of a transmission device decreases.

### Means for Solving the Problem

A device according to the present disclosure is configured to measure guided acoustic wave Brillouin scattering (GAWBS) of a measurement target optical fiber, and

detect a microbend in the measurement target optical fiber based on a characteristic around a peak of the guided acoustic wave Brillouin scattering.

A method according to the present disclosure includes the steps of:

measuring guided acoustic wave Brillouin scattering in a measurement target optical fiber; and

detecting a microbend in the measurement target optical fiber based on a characteristic around a peak of the guided acoustic wave Brillouin scattering.

### Effects of the Invention

According to the present disclosure, it is possible to detect a microbend in an optical fiber before the light-receiving intensity of a transmission device decreases.

### BRIEF DESCRIPTION OF DRAWINGS

FIG. 1 illustrates an example of GAWBS, with FIG. 1(a) showing a depolarized GAWBS and FIG. 1(b) showing a polarized GAWBS.

FIG. 2 illustrates an example of a spectral waveform of GAWBS.

FIG. 3 is an enlarged view of one of peaks of the spectral waveform of GAWBS.

FIG. 4 illustrates examples of temporal changes of GAWBS.

FIG. 5 illustrates examples of change rates until the maximum value of the transmission loss is reached.

FIG. 6 illustrates a first system configuration example according to a first embodiment.

FIG. 7 illustrates a second system configuration example according to the first embodiment.

FIG. 8 illustrates a third system configuration example according to the first embodiment.

FIG. 9 illustrates an example of a measurement target optical fiber.

FIG. 10 illustrates an example of a microbend detection method according to the first embodiment.

FIG. 11 illustrates a first system configuration according to a second embodiment.

FIG. 12 illustrates a second system configuration according to the second embodiment.

FIG. 13 illustrates a third system configuration according to the second embodiment.

FIG. 14 illustrates a fourth system configuration according to the second embodiment.

FIG. 15 illustrates a first configuration example of a detector included in the fourth system configuration example according to the second embodiment.

FIG. 16 illustrates a second configuration example of the detector included in the fourth system configuration example according to the second embodiment.

FIG. 17 illustrates a fifth system configuration example according to the second embodiment.

FIG. 18 illustrates a sixth system configuration example according to the second embodiment.

FIG. 19 illustrates a first example of a water immersion detection method according to a third embodiment.

FIG. 20 illustrates a second example of the water immersion detection method according to the third embodiment.

FIG. 21 illustrates a third example of the water immersion detection method according to the third embodiment.

### DESCRIPTION OF EMBODIMENTS

Hereinafter, embodiments of the present disclosure will be described in detail with reference to the drawings. Note that the present disclosure is not limited to the embodiments described below. These implementation examples are merely examples, and the present disclosure can be implemented in various forms modified and changed based on the knowledge of a person skilled in the art. Note that the constituent components with the same reference numerals in the present specification and the drawings indicate the same components.

<Principle>

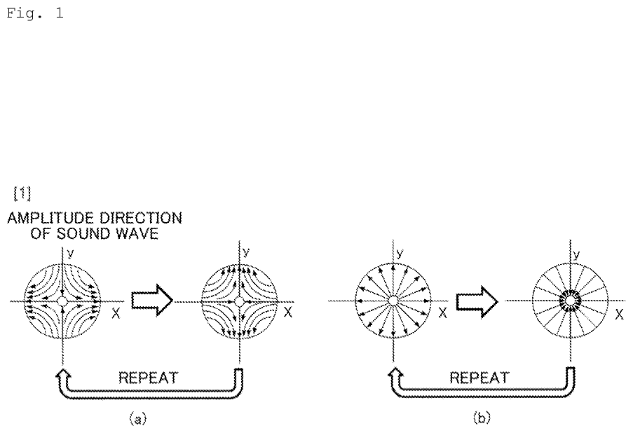

FIG. 1 shows examples of GAWBS (Guided acoustic-wave Brillouin scattering). In an optical fiber, heat is generated when a core absorbs light, and as a consequence thereof, sound waves are generated. GAWBS is a phenomenon in which due to the reflection of the sound waves traveling in a radial direction, the polarized wave and the phase of light that travels in the optical fiber are modulated. The GAWBS spectrum depends on a transmission loss of the sound waves, and is mainly caused by the reflectance of the sound waves. The reflectance of the sound waves in the optical fiber is affected by an acoustic impedance on the outside of the optical fiber. The acoustic impedance on the outside of the optical fiber changes with a change in a covering of the optical fiber.

It is conceivable that the state of the covering changes in a state in which a microbend may occur, and as a consequence of the change in the covering, the acoustic impedance also changes, resulting in a change in the spectrum. In the present disclosure, this change is used to detect a microbend in an optical fiber.

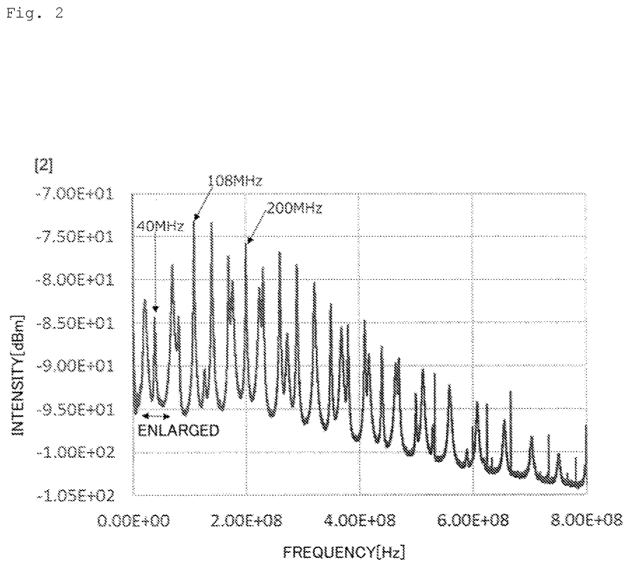

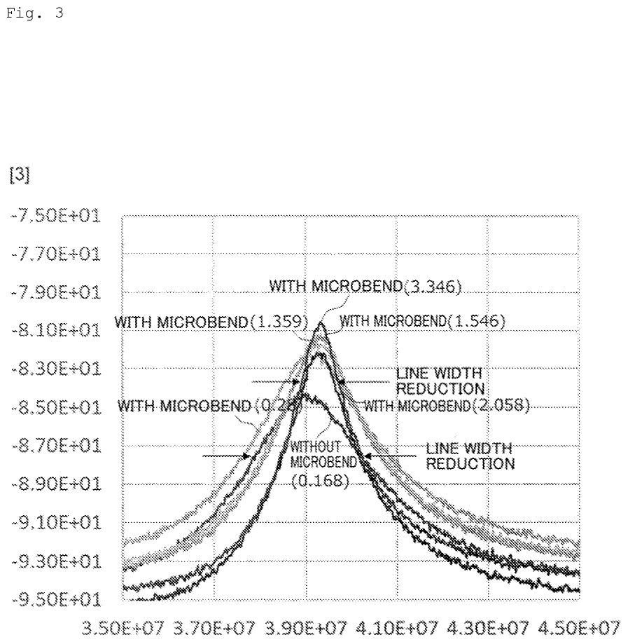

FIG. 2 shows an example of a spectral waveform of GAWBS. FIG. 3 is an enlarged view of one of peaks of the spectral waveform of GAWBS. In FIG. 3, values in parentheses indicate transmission losses. It is clear that the spectrum changes as the transmission loss increases due to occurrence of a microbend. Accordingly, in the present disclosure, an arbitrary combination of spectral changes of Guided Acoustic Wave Brillouin Scattering (GAWBS) as will be described below is used to detect a change in the state of the covering of an optical fiber.

Peak Frequency Intensity

As shown in FIG. 3, the intensity of the peak frequency of the spectrum of GAWBS increases with an increase in a loss caused by a microbend. The present disclosure can employ an aspect in which the intensity of a peak frequency of the spectrum of GAWBS is observed, and a microbend is detected based on an increase in the intensity.

Line Width of Spectrum of GAWBS

As shown in FIG. 3, the line width of the spectrum of GAWBS decreases with an increase in the loss caused by a microbend. The present disclosure can employ an aspect in which a microbend is detected based on a decrease in the line width of the spectrum of GAWBS. A line width can be calculated by approximating a spectrum with a Lorenz curve. The approximation with a Lorenz curve is calculated by performing fitting on a portion around every peak of the spectrum, using the Lorenz curve, for example.

Kurtosis of Spectrum of GAWBS

As shown in FIG. 3, the kurtosis of the spectrum increases with a decrease in the line width of the spectrum. Kurtosis refers to how sharp a spectrum compared to a normal distribution is. Accordingly, the present disclosure employs an aspect in which the kurtosis of a spectrum is observed, and a microbend is detected based on an increase in the kurtosis. For example, the kurtosis of a spectrum can be calculated by the following expression. Here, it is assumed that the sample size is denoted by n, an average value of pieces of data xi (i: 1, 2, . . . , n) is denoted by x, and a sample standard deviation is denoted by s.

$$\begin{matrix}[ Math . 1 ] & \\ \frac{n ( n + 1 )}{( n - 1 ) ( n - 2 ) ( n - 3 )} {{\sum }_{i = 1}}^{n} \frac{{( {x}_{i} - \overline{x} )}^{4}}{{s}^{4}} - \frac{3 {( n - 1 )}^{2}}{( n - 2 ) ( n - 3 )} & ( 1 )\end{matrix}$$

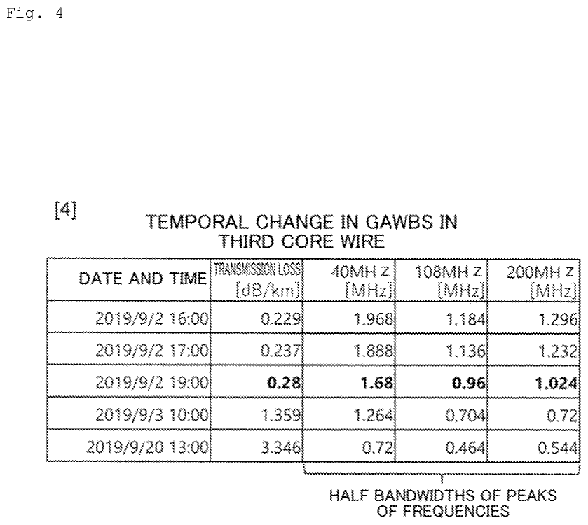

FIG. 4 illustrates examples of temporal changes of GAWBS. Each frequency is a frequency of a spectrum of GAWBS at which a peak exists. As of 2019 Sep. 2 16:00 at which no microbend has occurred, the half bandwidths of the peaks are 1.968 MHz at 40 MHz, 1.184 MHz at 108 MHz, and 1.296 MHz at 200 MHz. In contrast, as of 2019 Sep. 20 13:00 at which there is a loss due to a microbend, the half bandwidths of the peaks are 0.72 MHz at 40 MHz, 0.464 MHz at 108 MHz, and 0.544 MHz at 200 MHz. In this way, the half bandwidths of the peaks of the spectrum of GAWBS are reduced after the occurrence of a microbend.

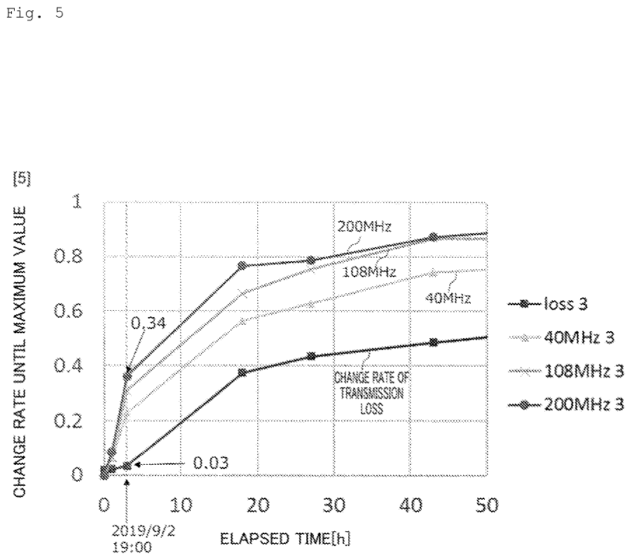

FIG. 5 illustrates examples of change rates until the maximum value of the transmission loss is reached. The change rate of a transmission loss was obtained by (maximum value−actual value)/(maximum value−minimum value). The change rate of a half bandwidth was obtained by (actual value−minimum value)/(maximum value−minimum value). It is clear that at any of the frequencies of 40 MHz, 108 MHz, and 200 MHz, the change rate of the half bandwidth is greater than the change rate of transmission loss. For example, at 200 MHz as of 2019 Sep. 2, 19:00, the change rate of the half bandwidth was 0.34, whereas the change rate of the transmission loss was 0.03. Accordingly, using the half bandwidth of the peak of the spectrum of GAWBS, it is possible to detect a microbend before the transmission loss is affected. In this way, by using a change in the waveform of a spectrum of GAWBS, it is possible to detect a microbend before a transmission loss is affected.

<Measurement Method>

A change in a spectrum of GAWBS due to a microbend occurs regardless of whether or not there is polarization of light. Although GAWBS includes polarized GAWBS and depolarized GAWBS, any of them can thus be used.

Also, although a spectrum of GAWBS includes a plurality of peaks, any of the peaks can be used. Note, however, that a low-frequency peak of the plurality of peaks also includes GAWBS between the covering and the external environment. In order to increase the efficiency of detecting a microbend loss, GAWBS between the covering and the external environment is preferably low. Accordingly, of the plurality of peaks, a relatively high frequency at which GAWBS between the covering and the external environment is low is preferably used. On the other hand, it is preferable to use, in the determination, a peak at which the intensity is the largest, that is, a frequency at which the intensity of a peak of the spectrum is large, for example.

Fourier transformation of a waveform of a spectrum analyzer or an oscilloscope can be used to measure a spectrum of GAWBS. Also, a Brillouin gain spectrum may also be used to measure a spectrum of GAWBS. Also, a frequency band in which a peak appears may be extracted by a filter in the measurement of a spectrum of GAWBS. This facilitates signal processing. Also, the spectrum is preferably subjected to arithmetic mean processing, so that measurement noise is reduced.

### First Embodiment

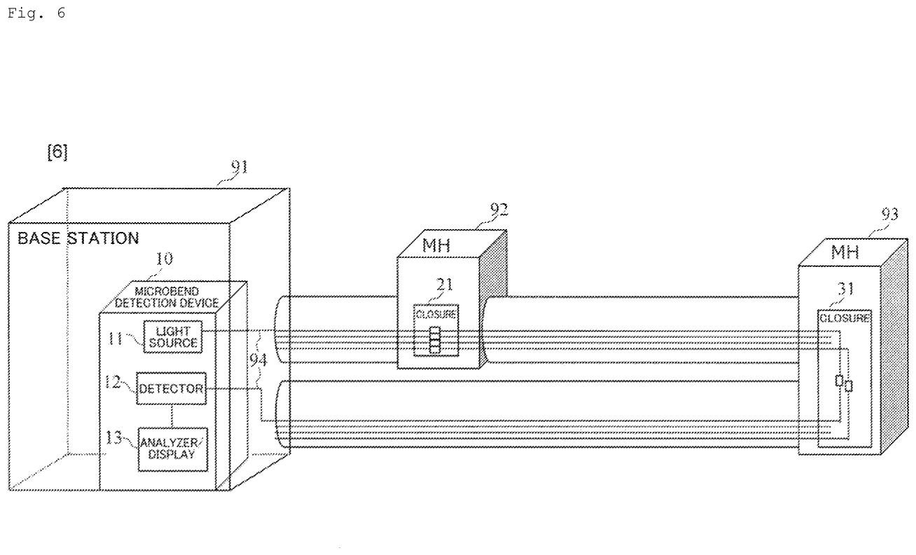

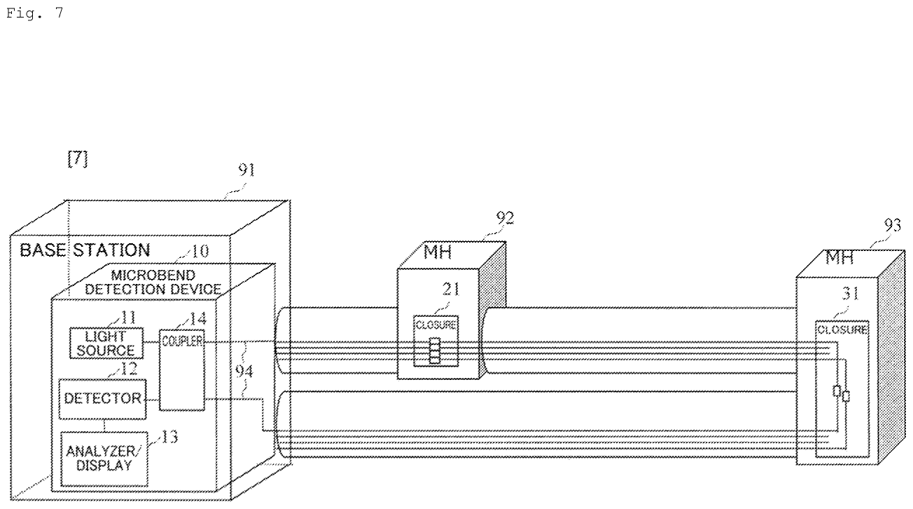

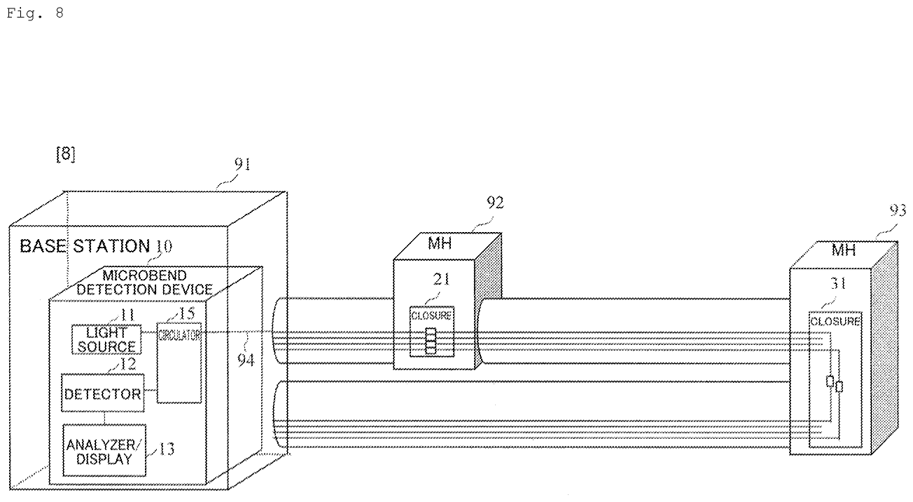

FIGS. 6 to 8 illustrate examples of a system configuration according to the present disclosure. A microbend detection device 10 according to the present disclosure is arranged within a base station 91 and is connected to a measurement target optical fiber 94. In a first system configuration example shown in FIG. 6 and a second system configuration example shown in FIG. 7, both ends of the measurement target optical fiber 94 are connected to the microbend detection device 10. In a third system configuration example shown in FIG. 8, one end of the measurement target optical fiber 94 is connected to the microbend detection device 10.

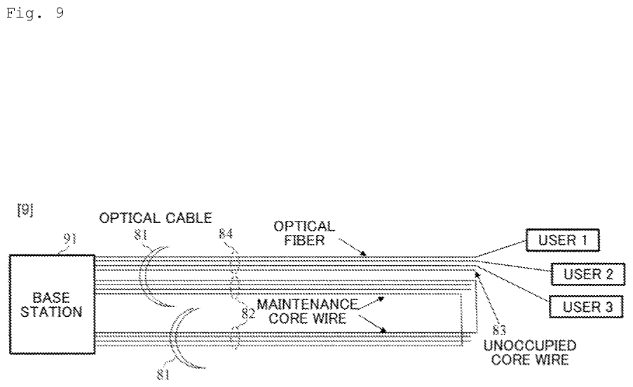

FIG. 9 illustrates an example of a configuration of a measurement target optical fiber. A cable 81 is connected to the base station 91. Each cable 81 buried in the ground includes maintenance core wires 82 assembled by a tape. The maintenance core wires 82 extend through closures 21 and 31 shown in FIGS. 6 to 8 and return to the base station 91. The maintenance core wires 82 are laid in a traversable manner. In the present disclosure, the maintenance core wires 82 can be used in the measurement target optical fiber 94 to measure GAWBS at both ends thereof. The present disclosure is not limited to the use of the maintenance core wires 82, and an unoccupied core wire 83 or an aerial cable (not shown) may also be used in the measurement target optical fiber 94 to measure GAWBS at one end thereof.

The microbend detection device 10 includes a light source 11, a detector 12, and an analyzer/display 13, and measures GAWBS. The light source 11 emits test light to the measurement target optical fiber 94. The test light has any wavelength. If an active line 84 is used in the measurement target optical fiber 94, the wavelength of 1650 nm, which is a test wavelength of the physical network, is used as the wavelength of the test light. The detector 12 detects scattering light obtained as the result of the test light being scattered by the measurement target optical fiber 94. The analyzer/display 13 measures GAWBS based on the scattering light detected by the detector 12. Then, the analyzer/display 13 detects an microbend in the optical fiber 94 based on a change in the spectrum. As described in the section <Principle>, the determination of an microbend uses the line width of the spectrum of GAWBS, or the intensity of a peak frequency of the spectrum of GAWBS.

The analyzer/display 13 of the microbend detection device 10 of the present disclosure can also be realized by a computer and a program, and the program can be recorded in a recording medium or can be provided via a network.

In the second system configuration example shown in FIG. 7, the microbend detection device 10 includes a coupler 14 to form a sagnac loop. As shown in FIG. 7, the present disclosure can employ a measurement system for general-purpose polarized GAWBS. In the configuration of FIG. 7, if GAWBS is measured by a BOTDA (Brillouin Optical Time Domain Analysis), a distance distribution may further be measured.

In the third system configuration example shown in FIG. 8, the microbend detection device 10 includes a circulator 15. The circulator 15 emits light from the light source 11 to the measurement target optical fiber 94, and emits scattering light from the measurement target optical fiber 94 to the detector 12. In the measurement at one end, if GAWBS is measured by a BOTDR (Brillouin Optical Time Domain Reflectometer), a distance distribution may further be measured.

When a distance distribution is measured, the results as shown in FIG. 3 can be obtained at positions in the longitudinal direction of the cable. By comparing the result obtained at each position with a threshold, it is possible to specify the position at which an microbend has been detected, and the distance from the microbend detection device 10. Using a database in which distances from the microbend detection device 10 to cables and cable installation positions are managed, it is possible to specify the position at which the cable with the detected microbend is installed.

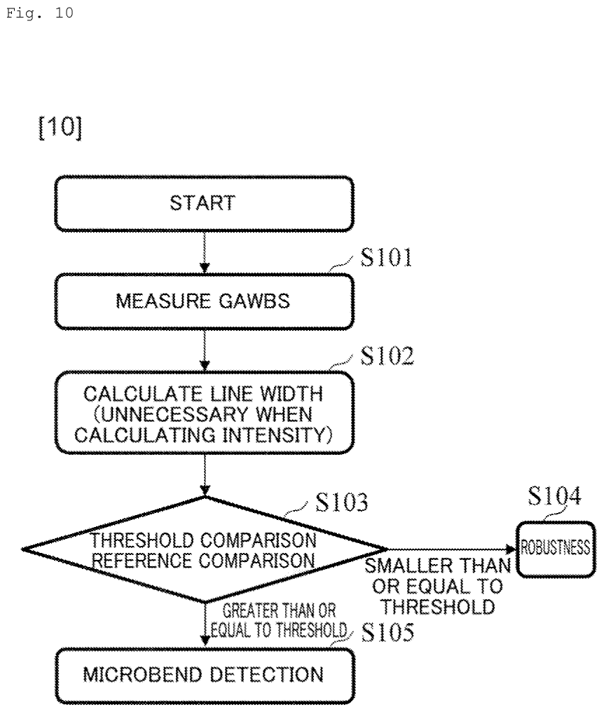

FIG. 10 illustrates an example of a microbend detection method according to the present embodiment. The microbend detection method of the present embodiment includes a GAWBS measurement step S101, a line width calculation step S102, a threshold comparison step S103, a robustness detection step S104, and a microbend detection step S105.

In the GAWBS measurement step S101, the light source 11, the detector 12, and the analyzer/display 13 measure GAWBS.

In the line width calculation step S102, the analyzer/display 13 calculates the line width of the spectrum of GAWBS.

In the threshold comparison step S103, the line width of the spectrum of GAWBS is compared with a predetermined threshold. If the line width of the spectrum of GAWBS is less than the predetermined threshold, the analyzer/display 13 determines that the measurement target optical fiber 94 does not have any microbend and is robust (S104). If the line width of the spectrum of GAWBS is greater than or equal to the predetermined threshold, the analyzer/display 13 determines that the measurement target optical fiber 94 has a microbend (S105).

In the robustness detection step S104, the analyzer/display 13 displays information indicating that the optical fiber 94 does not have any microbend and is robust.

In the microbend detection step S105, the analyzer/display 13 displays information indicating that the measurement target optical fiber 94 has a microbend. At this time, the analyzer/display 13 may transmit an alarm to a predetermined address.

Note that the present embodiment has given an example in which the line width calculation step S102 that uses the line width of a spectrum is executed, but any detection method using a spectrum can be used. For example, the line width calculation step S102 may be a step for calculating the intensity of a peak frequency, or may be a step for calculating the kurtosis of the spectrum.

As described above, the microbend detection device 10 of the present embodiment can detect a microbend that has occurred in the measurement target optical fiber 94. Here, by using a change in the spectral waveform of GAWBS, it is possible to detect a microbend before the transmission loss is affected. Therefore, in the present disclosure, it is possible to determine a microbend in the measurement target optical fiber before services are affected. Furthermore, the present invention can cover, in addition to the case where a microbend occurs due to immersion, a case where a microbend occurs due to a high temperature and high humidity environment, for example.

Here, the microbend detection device 10 preferably performs the above-described microbend detection method at regular intervals. When such automated measurement is performed, the analyzer/display 13 preferably transmits an alarm to a predetermined address in the microbend detection step S105.

In the automated measurement performed at regular intervals, it is preferable to renew the cable based on the change rates of the half bandwidths and transmission losses shown in FIG. 5, and calculate a time period until a threshold for the transmission loss is reached, the threshold being estimated from the change rate of the half bandwidth or the half bandwidth. When the time period until the cable is to be renewed is managed, it is preferable to shorten the interval of measurement of the core wire determined as having a microbend.

### Second Embodiment

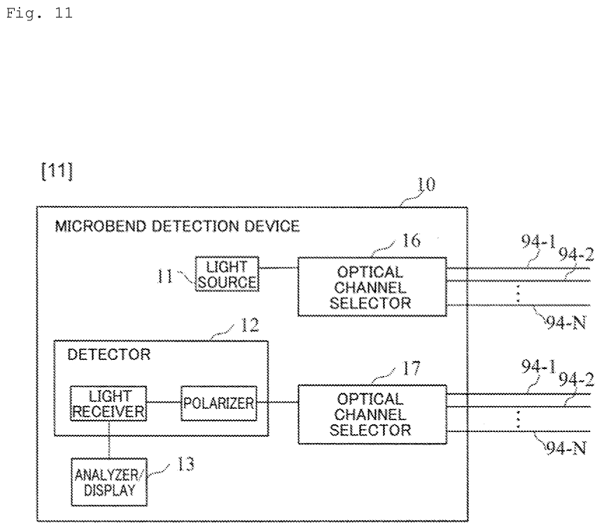

In the first embodiment, an example has been given in which GAWBS of the measurement target optical fiber 94 is measured, but the present disclosure is not limited thereto. For example, optical channel selectors 16 and 17 as shown in FIGS. 11 to 18 may be used to switch the measurement target optical fibers 94-1, 94-2, . . . , 94-N, so that a single microbend detection device 10 monitors a plurality of core wires or the optical fiber per unit of route. Also, the determination may also be performed per unit of cable by measuring a distance distribution of the spectrum of GAWBS.

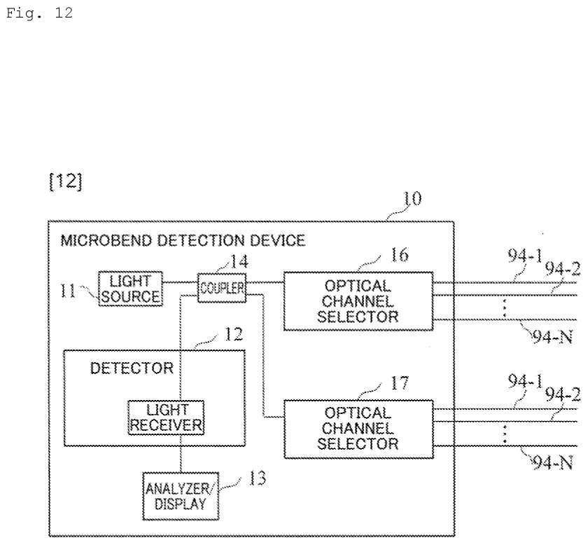

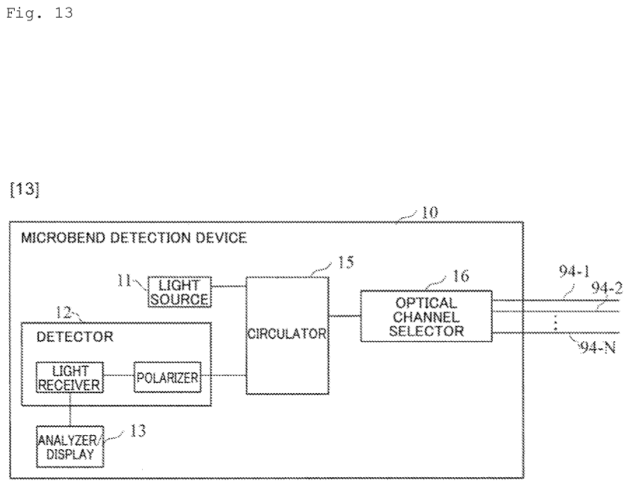

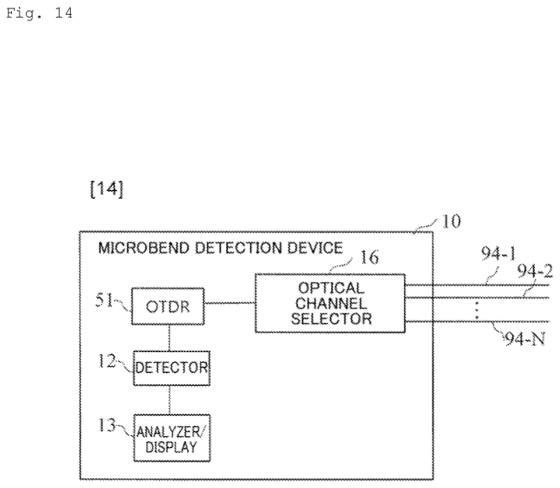

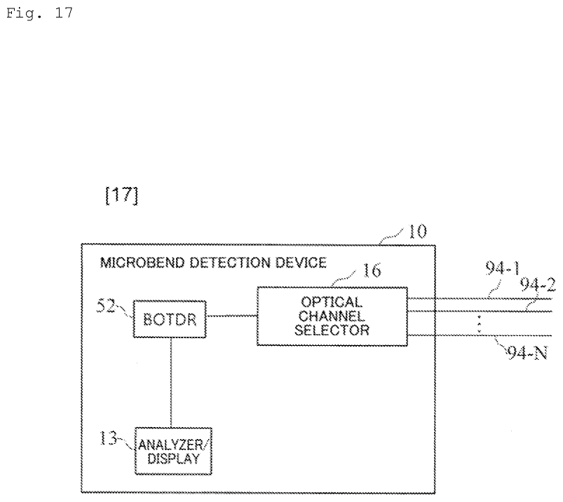

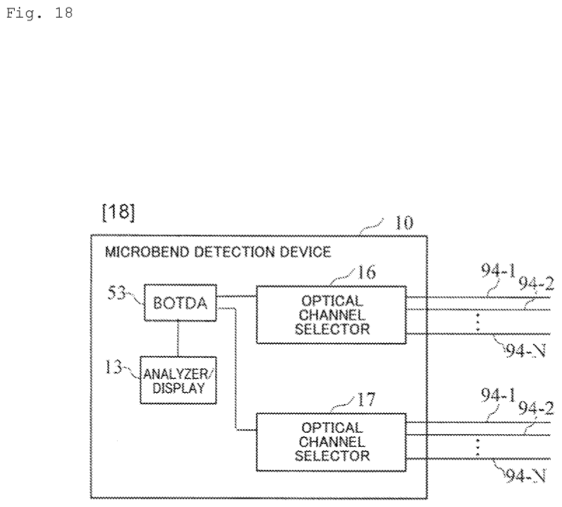

FIGS. 11 to 18 show examples of the microbend detection device 10 according to the present embodiment. The microbend detection device 10 according to the present embodiment includes the coupler 14 in the configuration of FIG. 12, includes the circulator 15 in the configuration of FIG. 13, includes an OTDR 51 in the configuration of FIG. 14, includes a BOTDR (Brillouin Optical Time Domain Reflectometer) 52 in the configuration of FIG. 17, or a BOTDA 53 in the configuration of FIG. 18.

In the configuration of FIG. 11, light from the light source 11 is output to the measurement target optical fiber 94, and a polarizer converts modulation due to GAWBS into intensity modulation of light. The analyzer/display 13 performs, using an oscilloscope, Fourier transformation on a signal of light received by the detector 12, or measures the spectrum of GAWBS using a spectrum analyzer.

In the configuration of FIG. 12, the coupler 14 outputs light from the light source 11 to both ends of the measurement target optical fiber 94. Also, the coupler 14 multiplexes light from both ends of the measurement target optical fiber 94, and outputs the resultant light. The coupler 14 converts modulation due to GAWBS into intensity modulation of light. The analyzer/display 13 performs, using the oscilloscope, Fourier transformation on a signal of the light received by the detector 12, or measures the spectrum of GAWBS using the spectrum analyzer.

In the configuration of FIG. 13, the circulator 15 outputs light from the light source 11 to the measurement target optical fiber 94. Also, the circulator 15 outputs light returned from the measurement target optical fiber 94. In the detector 12, a polarizer converts modulation due to GAWBS of the light returned from the circulator 15 into intensity modulation of the light. The analyzer/display 13 performs, using the oscilloscope, Fourier transformation on a signal of the light received by the detector 12, or measures the spectrum of GAWBS using the spectrum analyzer.

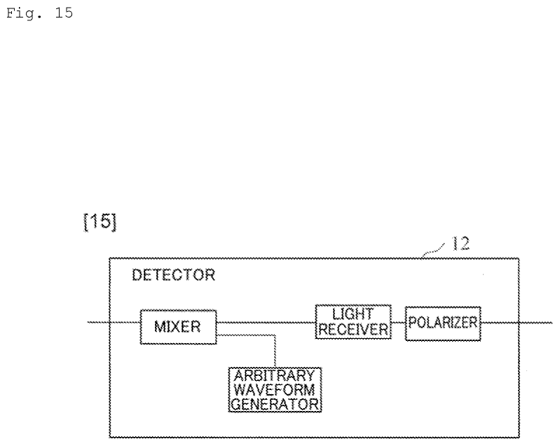

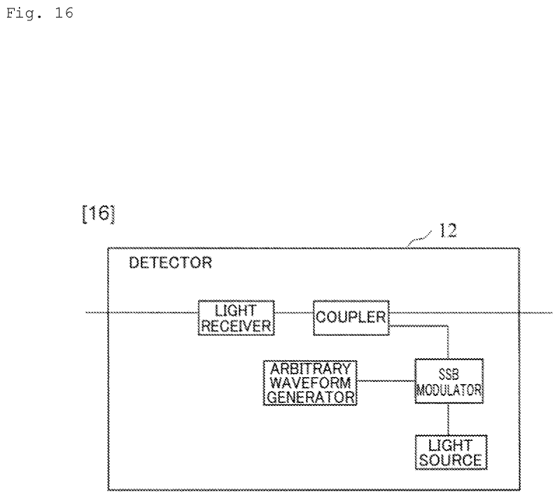

In the configuration of FIG. 14, the OTDR 51 outputs pulsed light to the measurement target optical fiber 94, and outputs light returned from the measurement target optical fiber 94. As shown in FIG. 15, in the detector 12, the polarizer may convert modulation due to GAWBS of the light returned from the OTDR 51 into intensity modulation of the light, or as shown in FIG. 16, a SSB (single side-band) modulator may convert the modulation due to GAWBS into intensity modulation of the light. As a light source that is used when the SSB modulator is employed, the light source 11 is preferably used to reduce measurement noise caused by the light source. The analyzer/display 13 can measure a distance distribution of a spectrum of GAWBS by determining a signal of light received by the oscilloscope of the detector 12, and performing measurement at each frequency while sweeping the frequency using an arbitrary waveform generator.

In the configuration of FIG. 17, the BOTDR 52 outputs pulsed light to the measurement target optical fiber 94, and outputs the spectrum of Brillouin scattering measured based on Brillouin scattering light that was returned from the measurement target optical fiber 94 and was modulated by the GAWBS. The analyzer/display 13 measures the GAWBS spectrum by subtracting, from the spectrum of Brillouin scattering measured by the BOTDR 52, a peak frequency (amount of shift of Brillouin scattering frequency) of the spectrum of Brillouin scattering.

In the configuration of FIG. 18, the BOTDA 53 outputs pulsed light and continuous light to the measurement target optical fiber 94, and outputs a spectrum of Brillouin scattering used to measure a gain or loss, the gain or loss being caused by the Brillouin scattering light modulated by GAWBS from the measurement target optical fiber 94. The analyzer/display 13 measures the GAWBS spectrum by subtracting, from the spectrum of Brillouin scattering measured by the BOTDA 53, a peak frequency (amount of shift of Brillouin scattering frequency) of the spectrum of Brillouin scattering.

### Third Embodiment

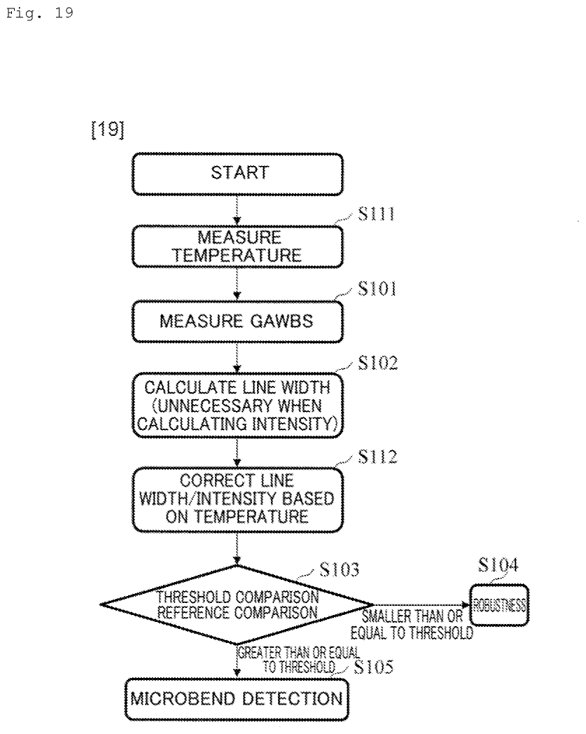

FIG. 19 illustrates a first example of the microbend detection method according to the present embodiment. The microbend detection method according to the present embodiment includes a temperature measurement step S111 before the GAWBS measurement step S101, and a temperature correction step S112 between the line width calculation step S102 and the threshold comparison step S103.

In the temperature measurement S111, as in the configuration of FIG. 17, the BOTDR or ROTDR (Raman Optical Time Domain Reflectometry) measures Brillouin scattering or Raman scattering in the measurement target optical fiber 94, and the analyzer/display 13 measures the distance distribution of temperatures of the measurement target optical fiber 94 using the Brillouin scattering spectrum or the Raman scattering spectrum. Alternatively, as in the configuration of FIG. 18, the BOTDA may measure a gain or loss caused by the Brillouin scattering in the measurement target optical fiber 94, and the analyzer/display 13 may measure the distance distribution of temperatures of the measurement target optical fiber 94 using the Brillouin scattering spectrum.

In the temperature correction step S112, the analyzer/display 13 corrects the line width calculated in the line width calculation step S102 based on the temperature of the measurement target optical fiber 94.

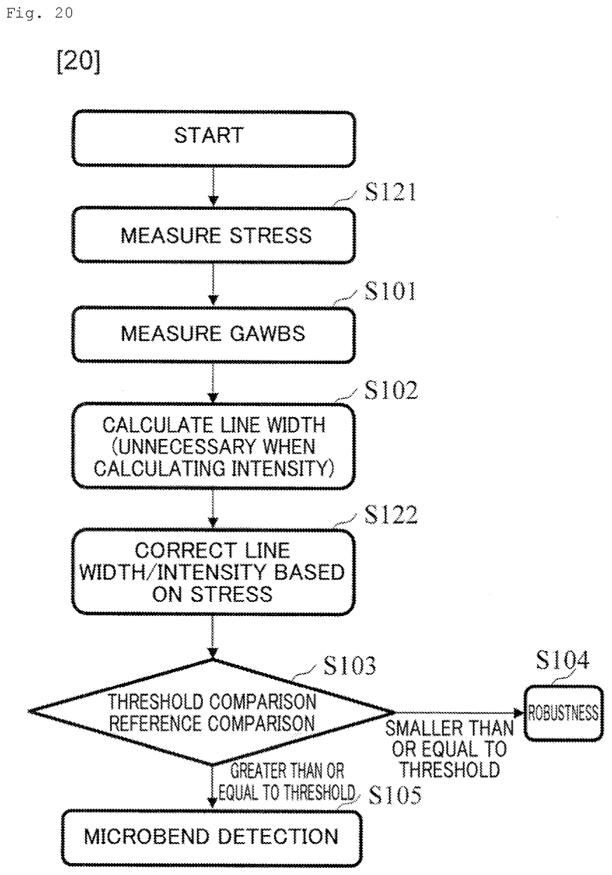

FIG. 20 illustrates a second example of the microbend detection method according to the present embodiment. The microbend detection method according to the present embodiment includes a stress measurement step S121 before the GAWBS measurement step S101, and a stress correction step S122 between the line width calculation step S102 and the threshold comparison step S103.

In the stress measurement step S121, as in the configuration of FIG. 17, the BOTDR 52 measures the Brillouin scattering in the measurement target optical fiber 94, and the analyzer/display 13 measures the distance distribution of stresses of the measurement target optical fiber 94 based on the Brillouin scattering spectrum. Alternatively, as in the configuration of FIG. 18, the BOTDA 53 may measure a gain or loss caused by the Brillouin scattering in the measurement target optical fiber 94, and the analyzer/display 13 may measure the distance distribution of stresses of the measurement target optical fiber 94 based on the Brillouin scattering spectrum. In the stress correction step S122, the analyzer/display 13 corrects the line width calculated in the line width calculation step S102 based on the stress of the measurement target optical fiber 94.

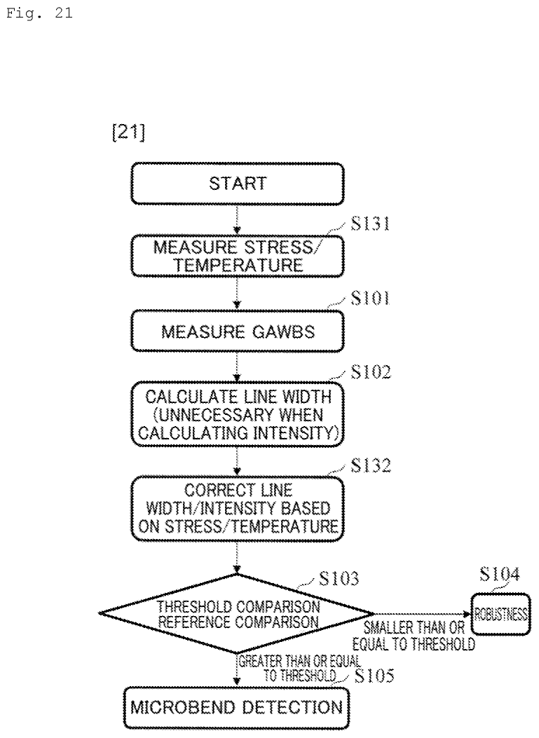

FIG. 21 illustrates a third example of the microbend detection method according to the present embodiment. The microbend detection method according to the present embodiment includes a temperature and stress measurement step S131 before the GAWBS measurement step S101, and a temperature and stress correction step S132 between the line width calculation step S102 and the threshold comparison step S103.

In the temperature and stress measurement step S131, as in the configuration of FIG. 17, the BOTDR 52 measures Brillouin scattering in the measurement target optical fiber 94, and the analyzer/display 13 measures the distance distribution of stresses of the measurement target optical fiber 94 based on the Brillouin scattering spectrum. Alternatively, as in the configuration of FIG. 18, the BOTDA 53 may measure a gain or loss due to the Brillouin scattering in the measurement target optical fiber 94, and the analyzer/display 13 may measure the distance distribution of stresses of the measurement target optical fiber 94 based on the Brillouin scattering spectrum. Also, as in the configuration of FIG. 17, the ROTDR measures the Raman scattering in the measurement target optical fiber 94, and the analyzer/display 13 measures the distance distribution of temperatures of the measurement target optical fiber 94 based on the Raman scattering spectrum.

In the temperature and stress correction step S132, the analyzer/display 13 corrects the line width calculated in the line width calculation step S102 based on the temperature and the stress of the measurement target optical fiber 94.

GAWBS is in linear relationship with the temperature. Also, GAWBS is in linear relationship with the stress. Accordingly, the analyzer/display 13 can detect a temperature change or a stress change based on the distance distribution of the measured temperatures and stresses, and can correct the GAWBS.

Note that the present embodiment has given an example in which the line width calculation step S102 using the line width of a spectrum is executed, and the line width is corrected, but the present invention can be applied to any detection method using the spectrum and correction thereof. For example, the line width calculation step S102 may be a step for calculating the intensity of a peak frequency. In this case, in the steps S112, S122, and S132, the intensity of the peak frequency is corrected.

### INDUSTRIAL APPLICABILITY

The present disclosure is applicable to the information and telecommunications industry.

### REFERENCE SIGNS LIST

10 Microbend detection device
11 Light source
12 Detector
13 Analyzer/display
14 Coupler
15 Circulator
16, 17 Optical channel selector
21, 31 Closure
41 Covering
42 Glass
43, 44 GAWBS
51 OTDR
52 BOTDR
53 BOTDA
81 Optical cable
82 Maintenance core wire
83 Unoccupied core wire
84 Active line
91 Base station
92, 93 Manhole
94 Measurement target optical fiber

1. A device configured to measure guided acoustic wave Brillouin scattering in a measurement target optical fiber, and
detect a microbend in the measurement target optical fiber based on a characteristic around a peak of the guided acoustic wave Brillouin scattering.

2. The device according to claim 1,
wherein the characteristic includes at least one type selected from a group consisting of at least one intensity, line width, and kurtosis that are included in the guided acoustic wave Brillouin scattering.

3. The device according to claim 1,
wherein the peak is one of a plurality of peaks that has the largest intensity.

4. The device according to claim 1, further comprising
an OTDR configured to measure a temperature of the measurement target optical fiber,
wherein the characteristic is corrected based on the measured temperature.

5. The device according to claim 1, further comprising
an OTDR configured to measure a stress of the measurement target optical fiber,
wherein the characteristic is corrected based on the measured stress.

6. A method comprising the steps of:
a device measuring guided acoustic wave Brillouin scattering in a measurement target optical fiber; and
the device detecting a microbend in the measurement target optical fiber based on a characteristic around a peak of the guided acoustic wave Brillouin scattering.

7. The method according to claim 6, further comprising the steps of:
the device measuring at least one of a temperature and a stress of the measurement target optical fiber, and
the device correcting the characteristic based on a result of the measuring.
